(19) United States
(12) Patent Application Publication
(10) Pub. No.: US 2022/0289237 A1
(43) Pub. Date: Sep. 15, 2022

(54) MAP-FREE GENERIC OBSTACLE DETECTION FOR COLLISION AVOIDANCE SYSTEMS

(71) Applicant: GM Cruise Holdings LLC, San Francisco, CA (US)

(72) Inventor: Trung-Dung Vu, Milpitas, CA (US)

(21) Appl. No.: 17/474,887

(22) Filed: Sep. 14, 2021

Related U.S. Application Data
(60) Provisional application No. 63/159,406, filed on Mar. 10, 2021.

(51) Int. Cl. B60W 60/00; B60W 30/09; B60W 30/095; G01S 17/89; G01S 17/931; G06K 9/00

(52) U.S. Cl. CPC B60W 60/0011; B60W 60/00274; B60W 30/09; B60W 30/0956; G01S 17/89; G01S 17/931; G06K 9/00805; B60W 2420/52

(57) ABSTRACT

Described herein are various technologies pertaining to a computing system for obstacle detection for an autonomous vehicle. The computing system receives a point cloud generated by a sensor of the autonomous vehicle. The computing system then forms a ground surface mesh based upon the point cloud. The ground surface mesh can be representative of location of ground relative to the sensor. The computing system further computes a likelihood that an object exists within a potential travel path of the autonomous vehicle based upon the ground surface mesh. The computing system yet further controls at least one of a braking system, a steering system, or a propulsion system of the autonomous vehicle based upon the likelihood that the object exists within the potential travel path.

### RELATED APPLICATION

This application claims priority to U.S. Provisional Patent Application No. 63/159,406 filed on Mar. 10, 2021 and entitled “MAP-FREE GENERIC OBSTACLE DETECTION FOR COLLISION AVOIDANCE SYSTEMS IN AUTONOMOUS VEHICLES”, the entirety of which is incorporated herein by reference.

### BACKGROUND

With respect to a collision avoidance system for an autonomous vehicle (AV), it is desirable to detect obstacles on the road so that the AV avoids the obstacles when the AV is autonomously navigating an environment. A light detection and ranging (LIDAR) system is a popular sensor used for obstacle avoidance, since the LIDAR system directly provides three-dimensional (3D) point clouds that indicate locations of objects in the environment of the AV.

Conventionally, in connection with detecting objects in an environment of an AV, deep learning-based approaches are employed. For instance, a deep neural network (DNN) (or other suitable machine-learned algorithm) can be trained with a relatively large amount of labeled training data where, once trained, the DNN can identify an object in a scene and assign a label to the object, where the label can indicate a type of the object—for instance: vehicle, pedestrian, bicycle, etc. However, since an obstacle on the road can be a wide variety of different objects, such as a construction cone, a vehicle, an animal, etc., it is nearly impossible to acquire enough training data to learn an algorithm that can identify objects of all object types.

Another conventional approach for obstacle detection is to use a map of an environment, where the map includes static features of the environment. When LIDAR data and/or image data of the environment is captured by a LIDAR system and/or cameras of an AV, the map is employed to filter out the static features represented in the LIDAR data and/or image data. Hence, remaining (unfiltered) LIDAR data and/or image data represents non-static objects. This approach, however, is problematic in that the approach is sensitive to map errors; additionally, environments are frequently subject to change, and it is challenging and time-intensive to keep a map of an environment up to date.

### SUMMARY

The following is a brief summary of subject matter that is described in greater detail herein. This summary is not intended to be limiting as to scope of the claims.

Described herein are various technologies pertaining to a computing system that is configured to detect obstacles around an autonomous vehicle (AV) based upon output of a sensor of the AV. With more specificity, the computing system receives a point cloud generated by a sensor system (such as a LIDAR system), where the point cloud is indicative of positions of objects in a scene relative to the AV. Based upon the point cloud, the computing system generates a ground surface mesh comprising a plurality of nodes, where the ground surface mesh is representative of elevation of the ground relative to the AV over some distance from the AV (e.g., 50 meters).

The computing system identifies data point(s) in the point cloud that are representative of an object (e.g., data points having height values that are greater than height value of a ground surface mesh at locations that vertically correspond to the data points). The computing system compares three-dimensional coordinates of the data point(s) with the ground surface mesh to determine height-above-ground for the object represented by the data point(s). The computing system can filter out data point(s) that correspond to objects that do not impede travel of the AV (e.g., objects that have an upper surface that is an inch off of the ground, overpasses that are several meters from the ground, etc.).

The computing system then generates a two-dimensional occupancy grid (that represents the environment at some distance from the AV, such as 20 meters), where the occupancy grid comprises a plurality of grid cells, and further where the occupancy grid is generated based upon remaining data points in the point cloud (data points that were not previously filtered out). The computing system computes an occupancy probability for each cell in the occupancy grid, where the occupancy probability for a grid cell represents a likelihood that a region in the environment represented by the grid cell includes an obstacle that is to be avoided by the AV.

The AV can then employ the occupancy grid to navigate in the environment. For instance, the AV can use the occupancy grid to avoid collision with the obstacle by computing a path moving forward in free/drivable space or triggering a brake if no feasible path can be found.

The above-described technologies present various advantages over conventional obstacle detection systems for AVs. Unlike the conventional approach of relying on a predefined map that needs to be kept up to date, the above-described technologies do not require a map and instead compute a ground surface mesh based upon live data generated by a sensor of the AV, and thus a computer-implemented representation of the ground surface proximate the AV is up to date. Moreover, the above-described technologies do not rely on a machine-learning algorithm that requires a large volume of training data with objects therein labeled by type. In addition, the above-described technologies are particularly well-suited for situations where emergency navigation is needed, such as when a map becomes unavailable, when there is power loss, etc., as the technologies described herein do not require processing resources required by conventional obstacle avoidance systems.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a schematic that illustrates an autonomous vehicle (AV) that includes a LIDAR sensor and a computing system for obstacle detection.

FIG. 2 illustrates a functional block diagram of a computing system that is configured to cause the AV to avoid obstacles when the AV is navigating an environment.

FIG. 3 illustrates a point cloud generated by a LIDAR system of an AV.

FIG. 4 illustrates a ground surface mesh generated by a computing system of the AV based on the point cloud illustrated in FIG. 3.

FIG. 5 illustrates an occupancy grid generated by the computing system of the AV based on the ground surface mesh illustrated in FIG. 4.

FIG. 6 is a flow diagram that illustrates an exemplary methodology for generating a ground surface mesh based on a point cloud generated by a sensor system.

FIG. 7 is a flow diagram that illustrates an exemplary methodology executed by a computing system for object detection for an AV.

FIG. 8 illustrates an exemplary computing device.

### DETAILED DESCRIPTION

Various technologies pertaining to an obstacle detection system that uses sensor data to generate an occupancy grid in a driving environment of an autonomous vehicle (AV) are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances. X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something and is not intended to indicate a preference.

Disclosed are various technologies that generally relate to a map-less obstacle detection system that generates an occupancy grid to identify locations of obstacles in a driving environment of a vehicle without aid of a previously generated computer-implemented map. The system generates a ground surface mesh that represents elevation of the ground relative to the vehicle. The system then compares the points in the point cloud to the ground surface mesh to determine height above the ground of objects represented by the points. The heights above ground are used to ascertain whether the points correspond to an obstacle to the vehicle. The system then generates a two-dimensional occupancy grid with grid cells to identify a location(s) of an obstacle without requiring identification of what the obstacle is and/or generating a bounding box around the obstacle. The grid cells include an occupancy probability indicating a likelihood that a region represented by the grid cell is occupied with an obstacle. These occupancy probabilities can be updated over time to account for noise and/or dust, rain, etc.

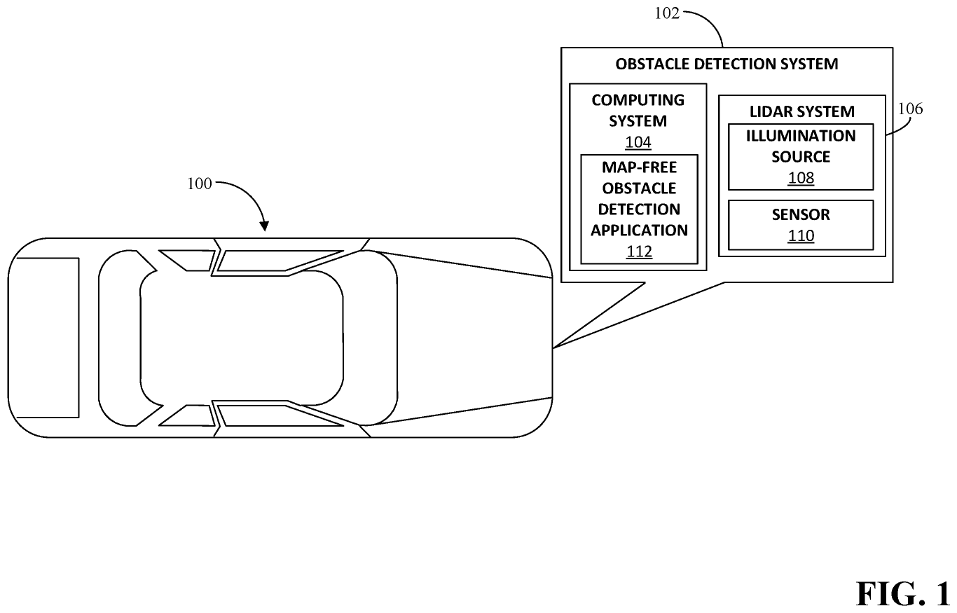

With reference now to FIG. 1, illustrated is an AV 100 that includes an obstacle detection system 102 configured to detect one or more obstacles in an environment of the AV 100. The obstacle detection system 102 includes a computing system 104 configured to detect an obstacle(s) in the external environment, via a map-free obstacle detection application 112 executing thereon, based on information generated by a sensor system that is configured to detect the external environment. The computing system 104 can be configured to identify a probable location of the obstacle and to determine whether a desired path of the AV passes through the probable location of the obstacle, as will be described in detail below.

In embodiments described herein the sensor system generates a point cloud comprising a plurality of data points for use by the computing system 104, where the data points are representative of the external environment of the AV 100. However, any suitable sensor system may be used to generate information about the external environment for use by the computing system 104. For instance, the sensor system may comprise stereoscopic cameras that capture images of the external environment of the AV 100, where depth information is generated based upon the images. In another example, the sensor system may comprise a radar sensor.

In the embodiment illustrated in FIG. 1, the sensor system comprises a light detection and ranging (LIDAR) system 106. The LIDAR system 106 is configured to emit laser illumination (via an illumination source 108), and a sensor 110 detects laser illumination upon such illumination reflecting off of a surface(s) in the external environment of the AV 100. The illumination source 108 can emit the laser illumination at any suitable rate, such as continuously and/or intermittently (e.g., every 100 microseconds). Moreover, the illumination source 108 can be configured to emit laser illumination simultaneously for a viewing area of the sensor 110 and/or can scan laser illumination across the viewing area of the sensor 110. The point cloud is generated based upon the reflected illumination detected by the sensor 110.

As briefly mentioned above, the computing system 104 uses this point cloud to detect potential obstacles in the environment of the AV 100, such as via the map-free obstacle detection application 112 that is executed by the computing system 104, as will be described in detail below. In one embodiment, the computing system 104 is configured to generate a ground surface mesh representing the ground in the external environment of the AV 100, where the ground surface mesh is generated based on the point cloud. The computing system 104 is further configured to compare points in the point cloud to the ground surface mesh to identify points in the point cloud that are “above” the ground surface mesh, wherein the computing system undertakes the comparison in connection with determining whether the aforementioned points represent an obstacle the AV 100 should avoid. The data points comprise three-dimensional coordinates which allows the computing system 104 to generate ground surface mesh representing the ground for any type of surface elevation with respect to the sensor 110 (e.g., inclined, declined, curved, etc.) and is not limited to estimating a uniform elevation with respect to the sensor 110. Moreover, the three-dimensional nature of the point cloud allows the computing system 104 to determine distance (e.g., height-above-ground) of objects represented by points in the three-dimensional point cloud from the ground, as represented by the ground surface mesh. This height-above-ground measurement can then be used to determine whether the points represent an obstacle to travel of the AV 100.

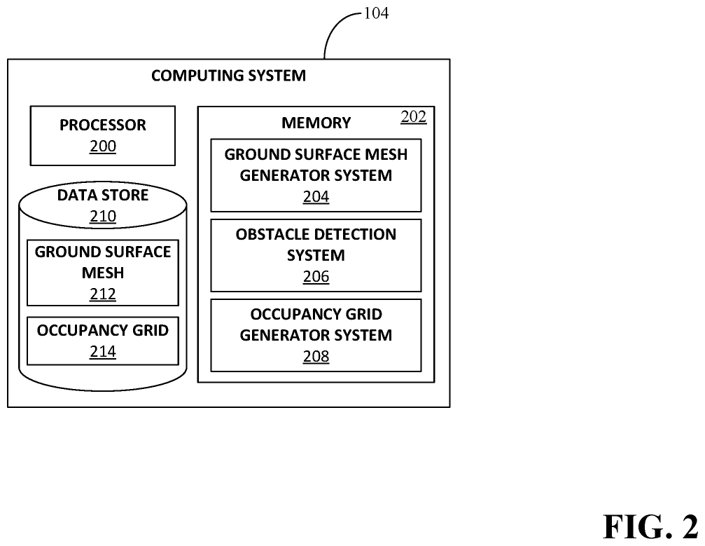

Turning now to FIG. 2, illustrated is an exemplary embodiment of the computing system 104 configured to generate the ground surface mesh and to compare a data point to the ground surface mesh to determine whether the data point represents an obstacle to the AV 100. The computing system 104 includes a processor 200 and memory 202 that includes computer-executable instructions that are executed by the processor 200. In an example, the processor 200 can be or include a graphics processing unit (GPU), a plurality of GPUs, a central processing unit (CPU), a plurality of CPUs, an application-specific integrated circuit (ASIC), a field programmable gate array (FPGA), a microcontroller, or the like.

The memory 202 includes a ground surface mesh generator system 204 configured to generate a ground surface mesh based on the point cloud from the sensor 110. The generated ground surface mesh comprises a three-dimensional mesh comprising a plurality of nodes that represent ground surface around the AV 100. A position of a node in the ground surface mesh can be determined based on one or more data points in the point cloud. For instance, the position of the node can be determined based on three-dimensional coordinates of a singular data point in the point cloud. In another example, the position of the node is synthesized from three-dimensional coordinates of multiple data points.

One particular method of generating the ground surface mesh will now be described; however, any suitable method of generating a ground surface mesh based upon a point cloud can be used. In a first step, the computing system 104 receives a point cloud Z comprising a plurality of data points, where the point cloud can be represented as follows:

Z={p₁,p₂, . . . ,pₘ}, (1)

where pᵢ=(x, y, z) represents three-dimensional coordinates of the data point i.

Subsequent to receiving the point cloud Z, the ground surface mesh generator system 204 classifies one or more of the data points in the point cloud Z as a ground or a non-ground measurement. This classification involves estimating whether a particular data point (e.g., p₁) represents laser illumination reflecting from the ground. An embodiment of performing this classification will now be described with respect to data point p₁, however, this embodiment can be performed with any of the data points in the point cloud Z.

The classification process begins by setting an initial ground surface to a previous iteration. For instance, the initial ground surface may be set as a previously generated ground surface mesh, which may be stored as a ground surface mesh 212 in a data store 210 in the computing system 104. In another example, where there is no previously generated ground surface mesh, the initial ground surface may be set as a calculated ground position with respect to a current position of the AV 100.

The computing system 104, when performing the classification process, then compares the data point to the initial ground surface mesh to determine whether the data point is a ground or a non-ground measurement. In one example, this comparison can include comparing the three-dimensional coordinates of the data point to the initial ground surface mesh (e.g., one or more nodes of the initial ground surface). Additionally and/or alternatively, the comparison can include comparing three-dimensional coordinates of the data point to three-dimensional coordinates of one or more adjacent data points in the point cloud Z. Subsequent to performing the comparison, the data point is then classified as either a ground measurement or a non-ground measurement.

This classification process can be performed for any suitable number of data points within the point cloud Z. For instance, the classification process may be performed on every data point in the point cloud Z. In another example, the classification process may be performed on data points that have three-dimensional coordinates within a threshold distance of the initial ground surface. After comparing the desired data point(s) to the initial ground surface, the ground surface mesh generator system 204 creates a point classification C. In an embodiment, all the data points in the point cloud Z are classified, resulting in a point classification C that can be represented as follows:

C={c₁,c₂, . . . ,cₘ}, (2)

where c_i∈{0, 1}. Each point in point classification C is tied to a respective data point in the point cloud Z and indicates whether point i is a ground (cᵢ=0) or a non-ground (cᵢ=1) measurement.

Subsequent to generating the point classification C, the ground surface mesh generator system 204 uses the point classification C and the point cloud Z to generate a ground surface mesh. In an initial step, the ground surface mesh generator system 204 determines which data point(s) to use to generate the ground surface mesh. More particularly, the ground surface mesh generator system 204 can use the point classification C to determine which data points represent a ground measurement based on their respective classification (e.g., when cᵢ=0). Subsequent to determining which data points represent a ground measurement, the ground surface mesh generator system 204 can use their respective three-dimensional coordinates from the point cloud Z to generate the node(s) for the ground surface mesh. As mentioned above, each data point can be used to generate a respective node in the ground surface mesh and/or multiple data points may be used to generate a singular node. The resulting ground surface mesh G comprising the nodes can be represented as follows:

G={g₁,g₂, . . . ,gₙ} (3)

where gᵢ represents the elevation of ground relative to the sensor 110 of the node at location i. By including elevation, the ground surface mesh G can account for contours in the road when determining whether a detected object comprises an obstacle, as will be described in detail below.

Subsequent to generating the ground surface mesh, the ground surface mesh generator system 204 may store the mesh for later use. The mesh can be stored at any suitable location, such as in the computing system 104 and/or a second computing system in communication with the computing system 104. In the embodiment illustrated in FIG. 2, the computing system 104 includes a data store 210 and one or more ground surface meshes 212 are stored therein. In one embodiment, each generated ground surface mesh can be individually stored. In another embodiment, each newly generated mesh replaces previously generated meshes. In a further embodiment, the generated meshes are synthesized together to form a singular mesh covering an area traveled by the AV 100.

In addition to the generated ground surface mesh being used for obstacle detection by the AV 100, the AV 100 can share the generated ground surface mesh with other AVs traveling in the mapped area for obstacle detection by the other AVs. The other AVs can use a shared ground surface mesh to determine an initial ground surface for obstacle detection.

Based upon the ground surface mesh, the computing system 104 is configured to determine which data point(s) in the point cloud, if any, represent an obstacle that impacts travel of the AV 100. The memory 202 of the computing system 104 further includes an obstacle detection system 206 configured to compare a data point in the point cloud to the ground surface mesh to determine whether the data point represents an obstacle to the AV 100. More particularly, the obstacle detection system 206 compares a height coordinate of a data point to a height coordinate of one or more nodes of the generated ground surface mesh to determine a relative height-above-ground of an object represented by the data point. For example, the obstacle detection system 206 can compare the height coordinate of a data point to height coordinates of nodes within a threshold distance of a footprint of the data point on the ground surface mesh to determine the height-above-ground corresponding to the data point. In another example, the obstacle detection system 206 can compare a data point to a select number of the nearest nodes (e.g., four) to the data point to determine the height-above-ground corresponding to the data point. The obstacle detection system 206 can determine this height-above-ground measurement for all data points classified as non-ground measurements and/or a portion of such data points.

Subsequent to determining height-above-ground with respect to one or more data points, the obstacle detection system 206 can filter out data points that do not represent obstacles to travel of the AV 100. In one embodiment, the obstacle detection system 206 may filter out data points that have corresponding heights above ground that are below a threshold height above ground. For instance, the obstacle detection system 206 may be configured to filter out data points that represent objects that the AV 100 is capable of driving over (e.g., plastic bag on the road, trash on the road, a branch, etc.). In one example, this threshold height may be variable and may depend on a ground clearance of the AV 100. In another embodiment, the threshold height is set to a height that would not obstruct a number of vehicle types, such as ten centimeters.

In another embodiment, the obstacle detection system 206 may filter out data points that have corresponding heights above ground that are above a second threshold height above ground. For instance, the obstacle detection system 206 may be configured to filter out data points that represent objects the AV 100 is capable of driving under (e.g., overhangs, bridges, etc.). In one example, the second threshold height may be variable and may depend on a clearance height of the AV 100. In another example, the second threshold may be selected to cover clearance heights for multiple vehicle types.

After filtering out data points below the threshold and/or above the second threshold, the remaining data points are measurements that may represent potential obstacles to travel of the AV 100. The remaining data points may be subject to noise from one or more of the sensors in the AV 100 and/or may represent spurious objects (e.g., rain, dust, etc.). Accordingly, the computing system 104 is further configured to spatially fuse the remaining data points through an occupancy grid framework in order to produce more reliable detection.

In the illustrated embodiment in FIG. 2, the memory 204 further includes an occupancy grid generator system 208 that generates a two-dimensional (2D) occupancy grid 214 based on the remaining data points, where the occupancy grid 214 comprises a plurality of grid cells. The grid cells include respective likelihoods that an obstacle is present in regions of the environment of the AV 100 represented by the grid cells. The likelihood is represented by an occupancy probability comprising a percentage chance that an obstacle is present in a region in the environment of the AV 100 represented by a grid cell, such as a 100% probability that an obstacle is present in a region represented by the grid cell, a 60% probability that an obstacle is present in the region represented by the grid cell, a 0% probability that an obstacle is present in the region represented by grid cell, etc.

The occupancy grid 214 can be stored in the data store 210 of the computing system 104 and/or transmitted to another computing system for storage. The computing system 104 can access and update the occupancy grid 214. For each grid cell, the relative occupancy probability can be updated using a binary Bayesian filter. More particularly, an occupancy probability of a grid cell can be updated and/or adjusted based on new information from one or more sensors (e.g., the LIDAR system 106, etc.) in the AV 100. As briefly mentioned above, the LIDAR system 106 can continuously and/or intermittently emit laser illumination and generate point clouds that can then be used to update an occupancy probability for at least one grid cell of the occupancy grid.

The computing system 104 can update the occupancy probability as new information is generated. In one exemplary embodiment of generating an occupancy probability for a grid cell of the occupancy grid and updating the occupancy probability, the computing system 104 receives a first point cloud from the LIDAR system 106 and generates a ground surface mesh representing a ground surface based upon the point cloud, such as via the ground surface mesh generator system 204. The computing system 104 then determines which data points in the point cloud represent potential obstacles for the AV 100, such as via filtering by way of the obstacle detection system 206. The computing system 104 then fuses those remaining data points representing potential obstacles to determine an occupancy probability for a grid cell in an occupancy grid.

The computing system 104 thereafter receives a second point cloud from the LIDAR system 106. The second point cloud can be generated at any time, such as 100 milliseconds (i.e., the LIDAR system 106 can generate a point cloud at 10 Hz) after the first point cloud was generated by the LIDAR system 106. The computing system 104 then generates a second ground surface mesh based on the second point cloud. The second ground surface mesh can replace and/or supplement the ground surface mesh previously generated by the computing system 104. The computing system 104 then determines which data points in the second point cloud represent potential obstacles for the AV 100. The computing system 104 can then determine a second occupancy probability for the grid cell by fusing those remaining data points representing potential obstacles.

This second occupancy probability can be synthesized with the occupancy probability previously generated to update the occupancy probability for the grid cell. For example, the computing system 104 can, based upon the first point cloud, set the occupancy probability at 100%. In one embodiment, the computing system 104 ascertains that no remaining data points correspond to the grid cell based upon the second point cloud, and the occupancy probability can be lowered to another probability, such as 50%.

Subsequent to generating and/or updating the occupancy probability for one or more of the grid cells in the occupancy grid, the computing system 104 can control the AV 100 to avoid a region represented by an occupancy cell based upon an occupancy probability computed for the occupancy cell. In one embodiment, the computing system 104 can control the AV 100 to avoid a region represented by an occupancy cell when the cell has an occupancy probability above a threshold percentage (e.g., 1%, 10%, etc.). Accordingly, by using the above-described technologies, the computing system 104 need not explicitly identify and label objects in the driving environment of the AV 100; rather, the computing system 104 can ascertain likelihoods that obstacles are at certain regions in the environment of the AV 100 without identifying and labeling the obstacles. Moreover, the computing system 104 need not define a bounding box to represent the object which may have accuracy issues when the object is moving, such as another vehicle, and/or the bounding box may have accuracy issues since the object may have an arbitrary shape which makes fitting the bounding box difficult.

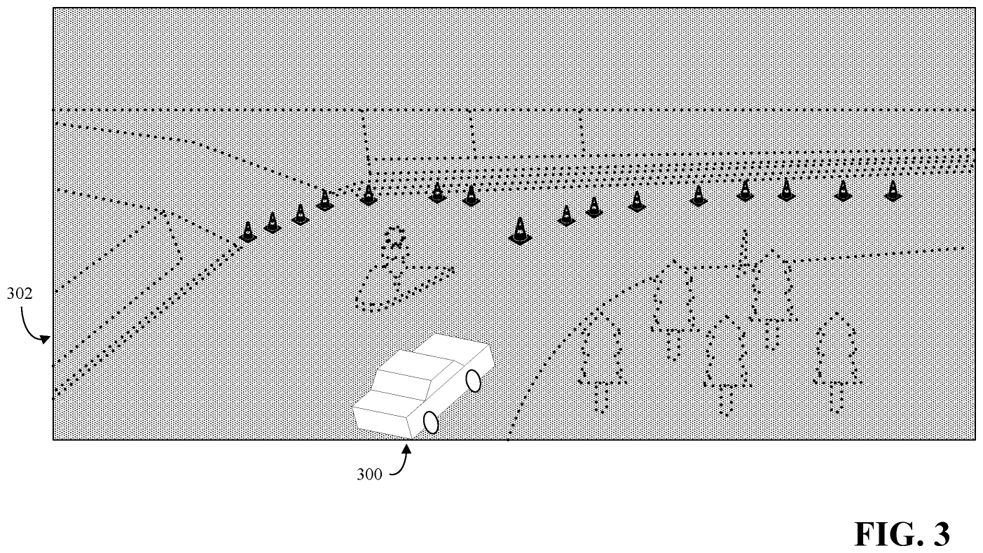

Turning now to FIGS. 3-5, illustrated is an embodiment of an AV 300 navigating a roadway using the above-described technologies. While the technologies are described with respect to the AV 300, it is to be understood that technologies described herein may be well-suited for driver-assistance systems in human-driven vehicles.

The AV 300 includes several mechanical systems that are used to effectuate appropriate motion of the AV 300. For instance, the mechanical systems can include, but are not limited to, a vehicle propulsion system, a braking system, and a steering system. The vehicle propulsion system may be an electric motor, an internal combustion engine, a combination thereof, or the like. The braking system can include an engine brake, brake pads, actuators, and/or any other suitable componentry that is configured to assist in decelerating the AV 300. The steering system includes suitable componentry that is configured to control the direction of the movement of the AV 300.

Illustrated in FIG. 3 is a point cloud 302 comprising data points generated by a LIDAR system of the AV 300. The data points comprise three-dimensional coordinates representing laser illumination reflecting off surfaces in the external environment. As can be seen in FIG. 3, the point cloud 302 represents the three-dimensional measurements for both a ground surface and objects on and/or above the ground surface, such as buildings, trees, overhangs, construction cones, etc.

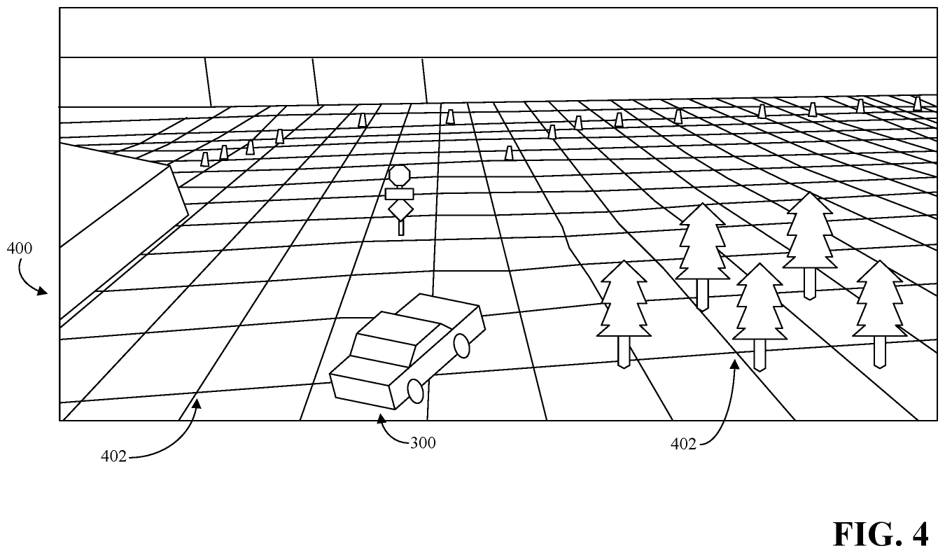

Turning now to FIG. 4, illustrated is a ground surface mesh 400 representing a ground surface around the AV 300 generated by the computing system 104 based on the point cloud 302 in FIG. 3. The ground surface mesh 400 comprises a plurality of nodes 402 each representing elevation of the ground surface at that respective node with respect to the LIDAR system in the AV 300. As discussed above, each node 402 is generated based on one or more data points in the point cloud 302.

In addition to the ground surface mesh 400, FIG. 4 depicts data points representing objects in the environment of the AV 300. As discussed above, the data points can be filtered based on their heights relative to the ground surface mesh 400. The remaining data points represent potential obstacles to the AV 300 in the environment of the AV 300.

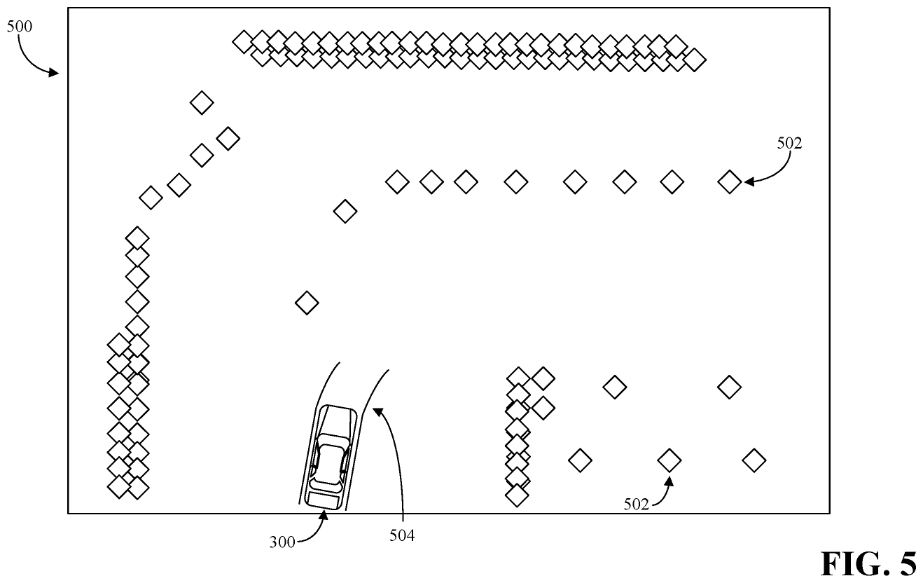

After filtering out data points that do not represent potential obstacles to the AV 300, the computing system 104 generates a two-dimensional occupancy grid 500 illustrated in overhead view in FIG. 5. The computing system 104 generates the occupancy grid 500 by spatially fusing and temporarily fusing (e.g., fused with the occupancy grid constructed in the previous step) the remaining data points to determine occupancy probability for one or more grid cells in the occupancy grid 500. In the illustrated embodiment, grid cells with an occupancy probability above a threshold amount (e.g., above 1%, 10%, etc.) are identified as including a potential obstacle to the AV 300, indicated at 502, while grid cells with an occupancy probability below the threshold are identified as not including a potential obstacle.

A predicted travel path of the AV 300, indicated by 504, is used with the occupancy grid 500 for collision checking. More particularly, the predicted path 504 is compared to the occupancy grid 500 to determine whether the predicted path 504 passes through a region represented by an occupied grid cell 502, where the occupancy grid cell has been labeled to indicate that an obstacle is located in the region. If the predicted path 504 passes through the region represented by the occupied grid cell 502, the vehicle propulsion system, the braking system, and/or the steering system can be controlled to navigate the AV 300 around the occupied grid cell 502 and/or slow or halt movement toward the occupied grid cell 502.

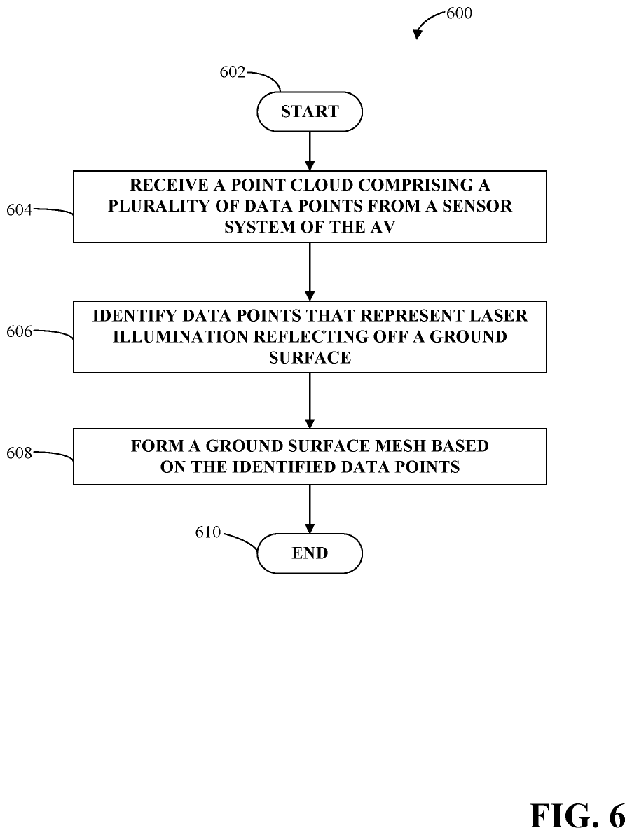

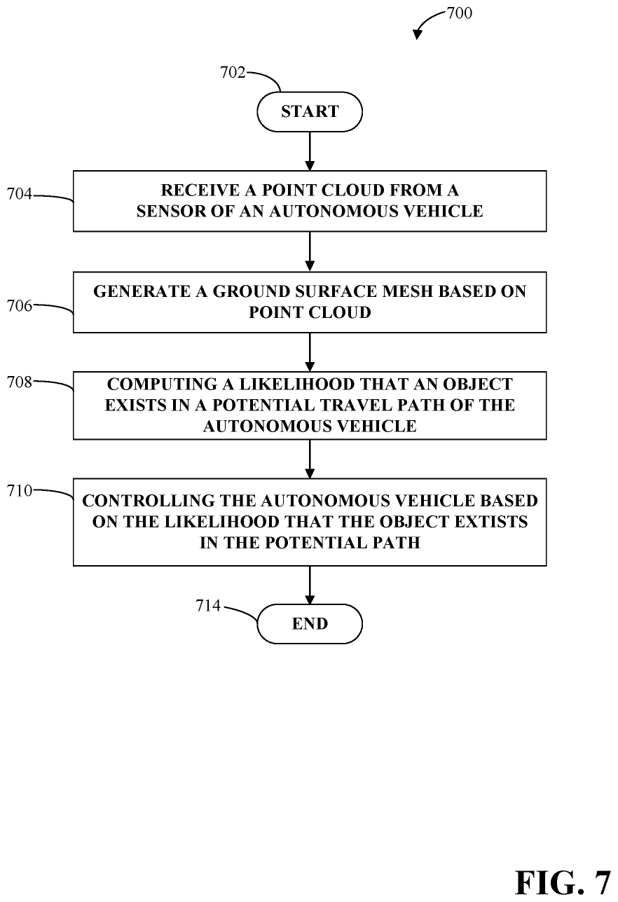

FIG. 6 illustrates an exemplary methodology 600 for generating a ground surface mesh based on lidar point cloud data. FIG. 7 illustrates an exemplary methodology 700 for generating an occupancy grid for obstacle detection. While the methodologies 600 and 700 are shown as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium displayed on a display device, and/or the like.

Referring now to FIG. 6, the methodology 600 begins at 602, and at 604, a computing system receives point cloud data generated by a sensor system of an AV, where the sensor system may be a LIDAR system, a radar system, or other suitable system that can be configured to generate a point cloud. At 606, the computing system identifies data points in the point cloud that represent a ground surface in an environment of the AV. Identifying the data points that represent the ground surface can comprise comparing data points in the point cloud to a previously generated representation of the ground surface in proximity to the AV. At 608, a ground surface mesh comprising a plurality of nodes is formed. Location of a node of the plurality of nodes can be based on one or more data points in the data points that represent the ground surface. The ground surface mesh can represent elevation of the ground relative to the sensor at the node. The methodology 600 ends at 610.

With reference now to FIG. 7, the methodology 700 for generating an occupancy grid for obstacle detection starts at 702, and at 704 a computing system of an AV receives a point cloud generated by a sensor of the AV. At 706, the computing system forms a ground surface mesh based upon the point cloud. The ground surface mesh can be representative of location of the ground surface relative to the sensor. At 708, the computing systems computes a likelihood that an object exists within a potential travel path of the AV based upon the ground surface mesh and further based upon data points in the point cloud that represent entities in the environment of the AV that are above the ground surface as represented by the ground surface mesh. At 710, the computing systems controls at least one of a braking system, a steering system, or a propulsion system of the autonomous vehicle based upon the likelihood that the object exists within the potential travel path. The methodology 700 ends at 712.

The features described herein relate to an obstacle detection system that uses sensor data to generate an occupancy grid in a driving environment of an AV according to at least the examples provided below:

(A1) In one aspect, some embodiments include an autonomous vehicle (AV) comprising a computing system comprising a processor and memory that stores computer-executable instructions that, when executed by the processor, cause the processor to perform acts. The acts include receiving, at the computing system, a point cloud generated by a sensor of the AV. The acts also include forming a ground surface mesh based upon the point cloud. The ground surface mesh can be representative of location of the ground relative to the sensor. The acts further include computing a likelihood that an object exists within a potential travel path of the AV based upon the ground surface mesh and further based upon data points in the point cloud that have height coordinates that are above height coordinates of the ground surface mesh at portions of the ground surface mesh that vertically correspond to the data points. The acts yet further include controlling at least one of a braking system, a steering system, or a propulsion system of the AV based upon the likelihood that the object exists within the potential travel path.

(A2) In some embodiments of the AV of (A1), the sensor of the AV is a LIDAR sensor system.

(A3) In some embodiments of the AV of at least one of (A1)-(A2), computing the likelihood that the object exists in the potential travel path of the AV comprises comparing the height coordinates of the data points to the height coordinates of the ground surface mesh to determine height-above-ground of the object represented by one or more of the data points.

(A4) In some embodiments of the AV of at least one of (A1)-(A3), computing the likelihood that the object exists in the potential travel path of the AV further comprises filtering the data points based on their respective height-above-ground.

(A5) In some embodiments of the AV of at least one of (A1)-(A4), filtering the data points comprises filtering out data points below a threshold height-above-ground.

(A6) In some embodiments of the AV of at least one of (A1)-(A5), the threshold height-above-ground is ten centimeters.

(A7) In some embodiments of the AV of at least one of (A1)-(A6), filtering the data points comprises filtering out data points above a threshold height-above-ground.

(A8) In some embodiments of the AV of at least one of (A1)-(A7), the threshold height-above-ground is a clearance height of the AV.

(A9) In some embodiments of the AV of at least one of (A1)-(A8), computing the likelihood that the object exists in the potential travel path of the AV further comprises generating a two-dimensional occupancy grid comprising a plurality of grid cells. Each grid cell of the plurality of grid cells includes an occupancy probability indicating a likelihood that a region represented by the corresponding grid cell is occupied by the object. The occupancy probability can be based on the filtered data points.

(A10) In some embodiments of the AV of at least one of (A1)-(A9), controlling the AV based on the likelihood comprises determining whether the potential travel path of the AV passes through a region represented by a grid cell of the plurality of grid cells with an occupancy probability above a threshold amount. Controlling the AV based on the likelihood further comprises controlling at least one of the braking system, the steering system, or the propulsion system of the AV to avert the AV travelling through the region represented by the grid cell with the occupancy probability above the threshold amount.

(A11) In some embodiments of the AV of at least one of (A1)-(A10), forming the ground surface mesh comprises comparing the point cloud to a previously identified location of ground relative to the sensor.

(A12) In some embodiments of the AV of at least one of (A1)-(A11), the acts yet further include receiving, at the computing system, a second point cloud generated by the sensor of the AV. The acts additionally include forming a second ground surface mesh based upon the second point cloud. The acts also include updating the likelihood that the object exists within the potential travel path of the AV based upon the second ground surface mesh and further based upon data points in the second point cloud that represent an obstacle above the second ground surface mesh.

(B1) In another aspect, some embodiments include a method, where the method includes receiving, at a computing system, a point cloud generated by a sensor of the AV. The method also includes forming a ground surface mesh based upon the point cloud. The ground surface mesh can be representative of location of ground relative to the sensor. The method further includes computing a likelihood that an object exists within a potential travel path of the AV based upon the ground surface mesh and further based upon data points in the point cloud that have height coordinates that are greater than height coordinates of nodes of the ground surface mesh that vertically correspond to the data points. The method yet further includes controlling at least one of a braking system, a steering system, or a propulsion system of the AV based upon the likelihood that the object exists within the potential travel path.

(B2) In some embodiments of the method of (B1), forming the ground surface mesh comprises comparing the point cloud to a previously identified location of ground relative to the sensor.

(B3) In some embodiments of at least one of the methods of (B1)-(B2), computing the likelihood that an object exists in the potential travel path of the AV comprises comparing the height coordinates of the data points that are greater than height coordinates of nodes of the ground surface mesh that vertically correspond to the data points to determine height-above-ground of the data points.

(B4) In some embodiments of at least one of the methods of (B1)-(B3), computing the likelihood that the object exists in the potential travel path of the AV further comprises filtering a subset of the data points based on their respective height-above-ground of the data points.

(B5) In some embodiments of at least one of the methods of (B1)-(B4), computing the likelihood that the object exists in the potential travel path of the AV further comprises generating a two-dimensional occupancy grid comprising a plurality of grid cells. Each grid cell of the plurality of grid cells includes an occupancy probability indicating a likelihood that a region represented by the corresponding grid cell is occupied by the object. The occupancy probability is based on the filtered data points.

(B6) In some embodiments of at least one of the methods of (B1)-(B5), the method further includes receiving, at the computing system, a second point cloud generated by the sensor of the AV. The method additionally includes forming a second ground surface mesh based upon the second point cloud. The method yet further includes updating the likelihood that the object exists within the potential travel path of the AV based upon the second ground surface mesh and further based upon data points in the second point cloud that are above the second ground surface mesh grid.

(C1) In another aspect, some embodiments comprise a computing system that comprises a processor and memory that stores computer-executable instructions that, when executed by the processor, cause the processor to perform acts. The acts include receiving, at the computing system, a point cloud generated by a sensor of the AV. The acts also include forming a ground surface mesh based upon the point cloud, wherein the ground surface mesh is representative of location of ground relative to the sensor. The acts additionally include computing a likelihood that an object exists within a potential travel path of the AV based upon the ground surface mesh and further based upon data points in the point cloud that have height coordinates that are greater than height coordinates of nodes of the ground surface mesh that vertically correspond to the data points. The acts further include controlling at least one of a braking system, a steering system, or a propulsion system of the AV based upon the likelihood that the object exists within the potential travel path.

(C2) In some embodiments of the computing system of (C1), the acts yet further include receiving, at the computing system, a second point cloud generated by the sensor of the AV. The acts additionally include forming a second ground surface mesh based upon the second point cloud. The acts further include updating the likelihood that the object exists within the potential travel path of the AV based upon the second ground surface mesh and further based upon data points in the second point cloud that have height coordinates that are greater than height coordinates of nodes in the second ground surface mesh that vertically correspond to the data points in the second point cloud.

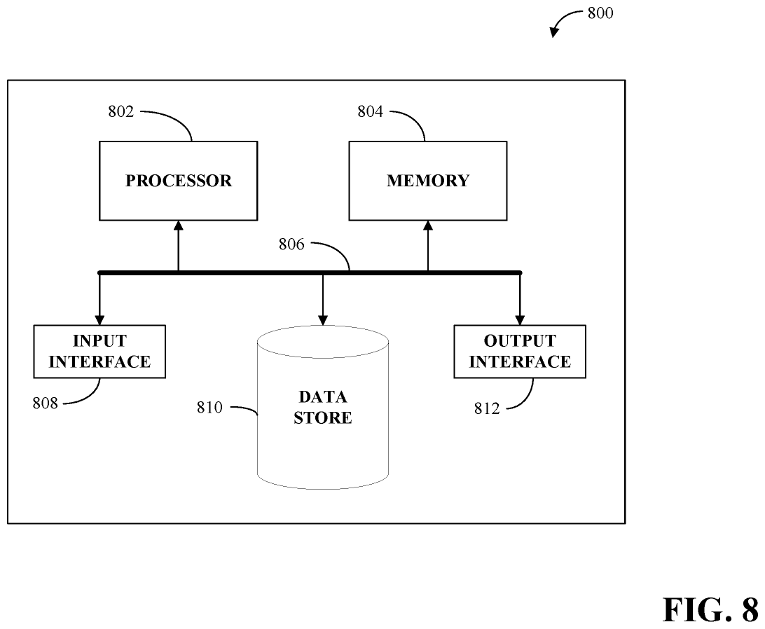

Referring now to FIG. 8, a high-level illustration of an exemplary computing device that can be used in accordance with the systems and methodologies disclosed herein is illustrated. For instance, the computing device 800 may be or include the computing system 104. The computing device 800 includes at least one processor 802 that executes instructions that are stored in a memory 804. The instructions may be, for instance, instructions for implementing functionality described as being carried out by one or more components discussed above or instructions for implementing one or more methods described above. The processor 802 may be a GPU, a plurality of GPUs, a CPU, a plurality of CPUs, a multi-core processor, etc. The processor 802 may access the memory 804 by way of a system bus 806. In addition to storing executable instructions, the memory 804 may also store images, point clouds, ground surface meshes, etc.

The computing device 800 additionally includes a data store 810 that is accessible by the processor 802 by way of the system bus 806. The data store 810 may include executable instructions, point clouds, ground surface meshes, occupancy grids, etc. The computing device 800 also includes an input interface 808 that allows external devices to communicate with the computing device 800. For instance, the input interface 808 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. An autonomous vehicle (AV) comprising:
a computing system comprising:
a processor; and
memory that stores computer-executable instructions that, when executed by the processor, cause the processor to perform acts comprising:
receiving, at the computing system, a point cloud generated by a sensor of the AV;
forming a ground surface mesh based upon the point cloud, wherein the ground surface mesh is representative of location of ground relative to the sensor;
computing a likelihood that an object exists within a potential travel path of the AV based upon the ground surface mesh and further based upon data points in the point cloud that have height coordinates that are above height coordinates of the ground surface mesh at portions of the ground surface mesh that vertically correspond to the data points; and
controlling at least one of a braking system, a steering system, or a propulsion system of the AV based upon the likelihood that the object exists within the potential travel path.

2. The AV of claim 1, wherein the sensor of the AV is a LIDAR sensor system.

3. The AV of claim 1, wherein computing the likelihood that the object exists in the potential travel path of the AV comprises comparing the height coordinates of the data points to the height coordinates of the ground surface mesh to determine height-above-ground of the object represented by one or more of the data points.

4. The AV of claim 3, wherein computing the likelihood that the object exists in the potential travel path of the AV further comprises filtering the data points based on their respective heights-above-ground.

5. The AV of claim 4, wherein filtering the data points comprises filtering out data points below a threshold height-above-ground.

6. The AV of claim 5, wherein the threshold height-above-ground is ten centimeters.

7. The AV of claim 4, wherein filtering the data points comprises filtering out data points above a threshold height-above-ground.

8. The AV of claim 7, wherein the threshold height-above-ground is a clearance height of the AV.

9. The AV of claim 4, wherein computing the likelihood that the object exists in the potential travel path of the AV further comprises generating a two-dimensional occupancy grid comprising a plurality of grid cells, wherein each grid cell of the plurality of grid cells includes an occupancy probability indicating a likelihood that a region represented by the corresponding grid cell is occupied by the object, wherein the occupancy probability is based on the filtered data points.

10. The AV of claim 9, wherein controlling the AV based upon the likelihood comprises:
determining whether the potential travel path of the AV passes through a region represented by a grid cell of the plurality of grid cells with an occupancy probability above a threshold amount; and
controlling at least one of the braking system, the steering system, or the propulsion system of the AV to avert the AV travelling through the region represented by the grid cell with the occupancy probability above the threshold amount.

11. The AV of claim 1, wherein forming the ground surface mesh comprises comparing the point cloud to a previously identified location of ground relative to the sensor.

12. The AV of claim 1, the acts further comprising:
receiving, at the computing system, a second point cloud generated by the sensor of the AV;
forming a second ground surface mesh based upon the second point cloud; and
updating the likelihood that the object exists within the potential travel path of the AV based upon the second ground surface mesh and further based upon data points in the second point cloud that represent an obstacle above the second ground surface mesh.

13. A method of maneuvering an autonomous vehicle (AV) comprising:
receiving, at a computing system, a point cloud generated by a sensor of the AV;
forming a ground surface mesh based upon the point cloud, wherein the ground surface mesh is representative of location of ground relative to the sensor;
computing a likelihood that an object exists within a potential travel path of the AV based upon the ground surface mesh and further based upon data points in the point cloud that have height coordinates that are greater than height coordinates of nodes of the ground surface mesh that vertically correspond to the data points; and
controlling at least one of a braking system, a steering system, or a propulsion system of the AV based upon the likelihood that the object exists within the potential travel path.

14. The method of claim 13, wherein forming the ground surface mesh comprises comparing the point cloud to a previously identified location of ground relative to the sensor.

15. The method of claim 13, wherein computing the likelihood that an object exists in the potential travel path of the AV comprises comparing the height coordinates of the data points that are greater than height coordinates of nodes of the ground surface mesh that vertically correspond to the data points to determine height-above-ground of the data points.

16. The method of claim 15, wherein computing the likelihood that the object exists in the potential travel path of the AV further comprises filtering a subset of the data points based on their respective height-above-ground of the data points.

17. The method of claim 16, wherein computing the likelihood that the object exists in the potential travel path of the AV further comprises generating a two-dimensional occupancy grid comprising a plurality of grid cells, wherein each grid cell of the plurality of grid cells includes an occupancy probability indicating a likelihood that a region represented by the corresponding grid cell is occupied by the object, wherein the occupancy probability is based on the filtered data points.

18. The method of claim 13, further comprising:
receiving, at the computing system, a second point cloud generated by the sensor of the AV;
forming a second ground surface mesh based upon the second point cloud; and
updating the likelihood that the object exists within the potential travel path of the AV based upon the second ground surface mesh and further based upon data points in the second point cloud that are above the second ground surface mesh grid.

19. A computing system comprising:
a processor; and
memory that stores computer-executable instructions that, when executed by the processor, cause the processor to perform acts comprising:
receiving, at the computing system, a point cloud generated by a sensor of the AV;
forming a ground surface mesh based upon the point cloud, wherein the ground surface mesh is representative of location of ground relative to the sensor;
computing a likelihood that an object exists within a potential travel path of the AV based upon the ground surface mesh and further based upon data points in the point cloud that have height coordinates that are greater than height coordinates of nodes of the ground surface mesh that vertically correspond to the data points; and
controlling at least one of a braking system, a steering system, or a propulsion system of the AV based upon the likelihood that the object exists within the potential travel path.

20. The computing system of claim 19, the acts further comprising:
receiving, at the computing system, a second point cloud generated by the sensor of the AV;
forming a second ground surface mesh based upon the second point cloud; and
updating the likelihood that the object exists within the potential travel path of the AV based upon the second ground surface mesh and further based upon data points in the second point cloud that have height coordinates that are greater than height coordinates of nodes in the second ground surface mesh that vertically correspond to the data points in the second point cloud.
